(19) United States
(12) Patent Application Publication
(10) Pub. No.: US 2012/0151310 A1
(43) Pub. Date: Jun. 14, 2012

(54) Method and system for identifying and delivering contextually-relevant information to end users of a data network

(76) Inventor: Ahmed M. El-kalliny, Redwood City, CA (US)

(21) Appl. No.: 12/928,494

(22) Filed: Dec. 13, 2010

(51) Int. Cl. G06F 17/30; G06F 17/00

(52) U.S. Cl. 715/205; 707/769; 715/230; 707/E17.014

(57) ABSTRACT

A method and system for identifying and delivering contextually-relevant information to end users of a data network is disclosed. A software plug-in is designed and adapted to work in cooperation with an electronic document reader software application. When a document is opened by the document reader application, the plug-in identifies relevant content within the document by means of keyword search rules utilizing keywords that are maintained in a keyword database. The plug-in then performs a markup of the original document for display to the user, either as a modification of the original document or in a separate popup window, by means of markup rules that extract relevant markup information from a contextual information database. In one preferred embodiment, the electronic document reader software application is Adobe Reader, and the keyword database contains a list of company names and associated product information. The plug-in performs a keyword search of the contents of the document in portable Document Format (PDF). Upon identification of a company name and/or a product in the subject document, associated product information is presented to the viewer. The product information may be supplemented with hyperlinks to company websites where additional product information, including purchasing information, may be found. The method is designed and adapted to execution on a computer network-based system.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of Invention

The present invention relates generally to the field of mapping contextual information for viewing by Internet users. More particularly, the present invention is a useful and novel computer-network-based method of identifying and delivering contextually-relevant information to end users of a data network, and a system for practicing the method. The method is designed and adapted for use in cooperation with a document reader software application to display relevant information or advertising to the user in the form of in-text and/or popup window displays. The method is particularly useful in the context of peer-reviewed literature, publications and journals.

2. Discussion of Related Art

The Internet revolutionized the communications world, becoming the dominant medium for information sharing. Measured in terms of the number of hosts, the Internet has grown from 72,398,092 hosts in January 2000 to 732,740,444 hosts in January 2010. (Source: Internet Domain Survey Host Count, Internet Systems Consortium Web Site, retrieved 15 Nov. 2010, <http://www.isc.org/solutions/survey>) As the quantity of information available on the Internet has increased exponentially, the need for, and usefulness of tools to bring relevant information to information seekers and to match buyers with sellers has been well recognized.

Several methods and systems have been developed to address the identified need. These related art methods and systems typically address generating markup information to be displayed on a user computer system. McBrearty, et al., U.S. Pat. No. 6,848,077 discloses a method and system for dynamically creating hyperlinks to hypertext documents accessible from sources on the World Wide Web. Goel, et al., U.S. Pat. No. 7,689,916 discloses a method and system of generating updates to tooltip information as a client displays a Web page. Henkin, et al., U.S. Pat. No. 7,478,089, discloses a method and system for real-time analysis and markup of Web page content.

These examples demonstrate that the related art is focused on the Web-browsing user. The related art is limited to methods that operate in the Web browser tool environment. What is needed is a method and system for identifying and delivering contextually-relevant information to users of document reader software applications. Such a method and system would be of particular benefit to users of peer-reviewed literature, such as scientific journals and research publications, who typically perform research using the tools in which peer-reviewed literature is created and viewed: document reader software applications.

Additionally, related art methods are reliant upon server-based applications to identify the document to be marked up and to initiate the keyword search and markup process. What is further needed is a tool that resides on the client system (e.g., on the user's computer), that recognizes the document automatically upon the user opening the document, and that initiates the document search and markup process from the client system without the reliance on, or the action of any server-based application.

### BRIEF SUMMARY OF THE INVENTION, ITS OBJECTS AND ADVANTAGES

In view of the foregoing limitations and disadvantages inherent to the known methods and systems in the related art, the present invention provides a novel, computer network-based method of identifying and delivering useful, contextually-relevant information to end users of a data network.

Specifically, the present invention enables keyword search, identification of contextually-relevant information, and markup of documents by means of a document reader software application. A document reader plug-in is installed on the user computer. The plug-in enhances the capabilities of the document reader application to include search, contextual analysis and document markup rules and functions.

On one preferred embodiment, the document reader plug-in resides on the end user's computer. The plug-in accesses keyword and contextually-relevant information maintained in a remote plug-in host location by means of a host application program interface (host API). In an alternative implementation of this embodiment, the keyword and contextually-relevant information is maintained in the user computer memory. In one enhancement of the method, the plug-in executes a Web search for additional contextually-relevant information by means of a Web search program application interface (Web search API). Employing the contextually-relevant information from the contextual information database and/or the Web search, the plug-in creates a markup of the document, by means of a document reader program application interface (document reader API), which is displayed to the user in the form of a modified document and/or a pop-up window. In a second preferred embodiment, the document reader plug-in is hosted at a remote server location.

A principal objective of the present invention is to identify and deliver contextually-relevant information to users of document reader applications. This objective is achieved by means of the document reader plug-in, either installed on the client system/user computer or hosted at a remote server location, which cooperates with document reader applications such as Adobe Acrobat Reader, Foxit Reader, Microsoft Word Viewer, and others.

Enabling the markup of documents that are viewed by means of a document reader provides is particularly advantageous to users of peer-reviewed literature, such as scientific journals and research publications, who typically perform research using the tools in which peer-reviewed literature is created and viewed: document reader applications. The document reader plug-in-based method/system provides the user with access to contextually-relevant information any time the user opens a document in the document reader format, not merely when the document is opened in a Web browser.

The plug-in rules may be tailored to efficiently search the document in accordance with conventions established for peer-reviewed literature. For example, publications that present the results of experiments will include a Materials & Methods section which will identify the specific materials/products employed in the experiment, followed by the name of the source company of the material/product. The plug-in search rules may be designed to take advantage of such conventions to efficiently associate relevant products with the identified company name. Such tailoring of the plug-in rules targets the search, eliminating guessing as to the contextual use of the keyword, and significantly enhances the relevance, quality and usefulness of information presented to the user.

Simplicity of operation is an objective of the present invention. The document reader plug-in method/system achieves simplicity by automatically operating whenever a document is opened in the document reader. Further, there is no need for the plug-in to identify the format or source URL of the document. The format will always be that of the document reader. The source URL is irrelevant.

Another objective of the present invention is to perform continuous update of the database of contextually-relevant information. In one embodiment of the present invention, this advantage is achieved by means of a Web search, the results of which are added to the contextual information database.

A further objective of the present invention is to transform a general-purpose user computer into a computer specifically configured for the purpose of identifying and delivering tangible, contextually-relevant information to the user. This configuring of the user computer is accomplished by loading the document reader plug-in onto the user computer. The enabling computer network system is disclosed herein.

Other objects and advantages of the present invention will become readily apparent to those with skill in the art from the following figures, descriptions and claims. As will be appreciated by those with skill in the art, the method of the present invention may be implemented in a plurality of equivalent steps; the system may be implemented in a plurality of equivalent embodiments. Such alternative process steps and system embodiments, and their attendant objectives and advantages, are intended to be within the scope of the present invention and, therefore, the examples set forth herein shall not be limiting.

### BRIEF DESCRIPTION OF THE DRAWINGS

The nature of this invention, as well as all its objects and advantages, will become readily apparent and understood upon reference to the following detailed description when considered in conjunction with the accompanying drawings, in which like reference numerals designate like parts throughout the figures thereof, and wherein:

FIG. 1 provides a schematic representation of a first preferred embodiment of the computer network-based system for implementing a first preferred embodiment of the method of the present invention.

FIG. 2 provides a process flow diagram showing the steps in a first preferred embodiment of the method of the present invention.

FIG. 3 presents a screen shot of the user's computer display showing a sample document opened in a document reader application as it would be displayed prior to markup by the present invention.

FIG. 4 presents a screen shot of the user's computer display showing a portion of the document, marked up with contextually-relevant information, as displayed to the user in one embodiment of the present invention.

FIG. 5 provides examples of the keyword database and the contextual information database employed to create the marked up document.

FIG. 6 provides a schematic representation of a second preferred embodiment of the computer network-based system for implementing a second preferred embodiment of the method of the present invention.

FIG. 7 provides a process flow diagram showing the steps in a second preferred embodiment of the method of the present invention.

### DETAILED DESCRIPTION OF THE PREFERRED EMBODIMENTS

The following description is provided to enable any person skilled in the art to make and use the invention and sets forth the best modes contemplated by the inventor of carrying out the invention. The present invention shall not be limited to the examples disclosed. Rather, the scope of the invention shall be as broad as the claims will allow.

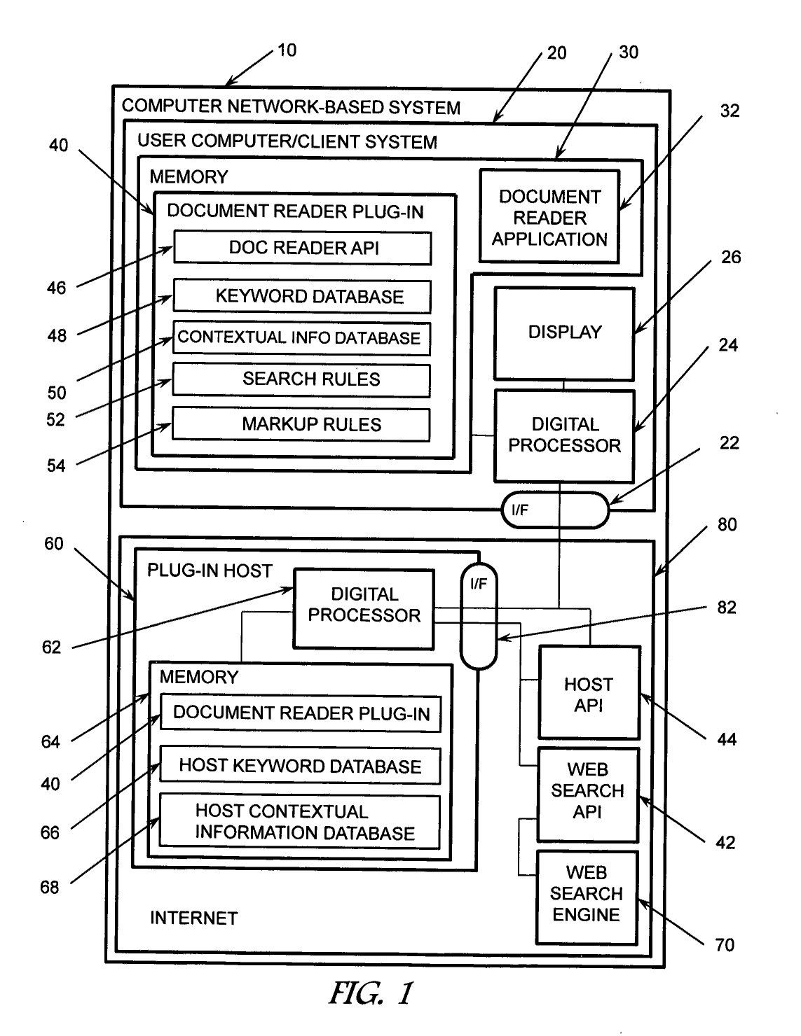

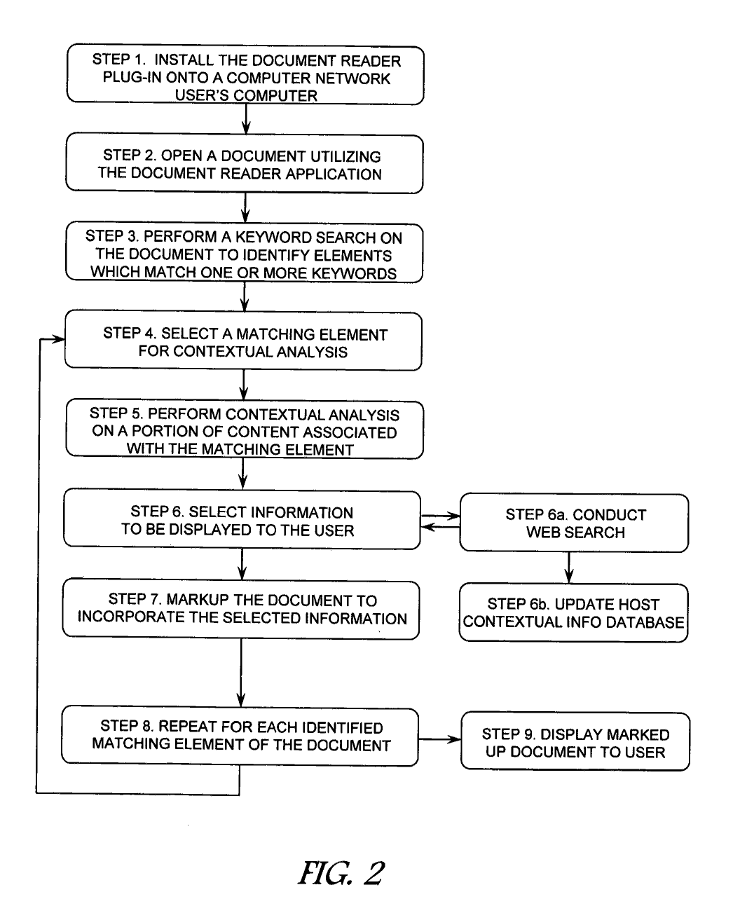

Referring now to the drawings, FIG. 1 provides a schematic representation of a first preferred embodiment of the computer network-based system 10 for implementing a first preferred embodiment of the method of the present invention, to be provided in FIG. 2. The computer network-based system 10 is comprised of the user computer/client system 20, the Web-based plug-in host 60, and, within the Internet environment 80, the host API 44 for interfacing with the remotely-located plug-in host 60, the Web search API 42 for interfacing with the remotely-located Web search engine 70, and the Web search engine 70.

In one preferred embodiment of the present invention, the user computer 20 is comprised of a digital processor 24, a network interface 22 designed and configured to provide access to the Internet 80, a memory 30, and a display 26. The memory 30 hosts a document reader application 32 and a document reader plug-in 40 (which is downloaded from the plug-in host 60 to the user computer/client system 20 in this preferred embodiment of the present invention). The document reader plug-in 40 hosts a document reader API 46 for interfacing with the document reader application 32. The document reader plug-in 40 also hosts search rules 52 and markup rules 54 which contain instructions for the search and markup functions, respectively. Finally, the document reader plug-in 40 hosts the keyword database 48, which is utilized by the search rules 52, and the contextual information database 50, which is utilized by the markup rules 54.

In one preferred embodiment of the present invention, the plug-in host 60 is comprised of a digital processor 62, a memory 6, and a network interface 82 designed and configured to provide access to the Internet 80. The memory 64 hosts the document reader plug-in 40 (which is downloaded to the user computer/client system 20 from the plug-in host 60 in the preferred embodiment of the present invention), the host keyword database 66 which contains the latest updated keyword search data, and the host contextual information database 68 which contains the latest updated contextual information data.

The present invention may utilize any useful Web search engine 70, such as Google, Bing or Yahoo, among others.

FIG. 2 provides a process flow diagram showing the steps in a first preferred embodiment of the method of the present invention. Step 1 is to install the document reader plug-in 40 onto a computer network user's computer 20. In one preferred embodiment of the present invention, the document reader plug-in 40 is downloaded from the plug-in host 60 to the user computer/client system 20. Alternatively, the plug-in 40 may be installed on the user computer 20 from a compact disc, or by any other practical means.

In Step 2, the user opens a document 2 utilizing the document reader application 32. Alternatively, the document may be opened within a Web browser.

Step 3 is to perform a keyword search of the content of the document 2 to identify elements in the document 2 which match one or more keywords. The document reader plug-in 40 employs the keyword database 48 hosted in the user computer memory 30 in accordance with the search rules 52, also hosted in the user computer memory 30, to identify matching elements within the content of the document 2 on which to perform contextual analysis. In a preferred embodiment of the present invention, the keywords consist of company names. In one alternative implementation of the method, the user computer 20 accesses the host keyword database 66 which resides on the remote plug-in host 60 to update the keyword database 48 prior to conducting the keyword search. In yet another alternative implementation, the user computer 20 accesses the search rules 52 residing in the plug-in host 50 to update the search rules 52 residing in the document reader plug-in 40 prior to conducting the keyword search.

In Step 4, a first matching element is selected for contextual analysis. Step 5 is to perform contextual analysis on a portion of the content of the document 2 associated with the first matching element. The user computer 20 employs the contextual information database 50 in accordance with search rules 52 to identify relevant information within the document 2 associated with the first matching element to further tailor the selection of information to be provided to the user. In a preferred embodiment of the present invention, the relevant information consists of product names that are contained in the contextual information database 50. In one alternative implementation of the method, the user computer 20 accesses the host contextual information database 68 which resides on the remote plug-in host 60 to update the contextual information database 50 prior to performing the contextual analysis.

In Step 6, the document reader plug-in 40 selects the text within the document 2 to be marked up in accordance with the markup rules 54. In Step 6, the document reader plug-in 40 selects the contextually-relevant information contained in the contextual information database 50 to be incorporated into the document 2. The user computer 20 accesses the contextual information database 50 and selects the information to be presented to the user. In one preferred embodiment of the present invention, Step 6a is performed in conjunction with Step 6. In Step 6a, the user computer 20 interfaces with a Web search engine 70 by means of a Web search API 42 and initiates a search of the Internet 80 for contextually-relevant information that is not currently contained in the contextual information database 50. This additional contextually-relevant information is added to the contextual information database 50 to ensure that the latest available information is made available for the document markup operation. In Step 6b, this additional information is added to the host contextual information database 68 to enhance the fidelity of the host contextual information database 68 on an on-going basis.

Step 7 is to markup the document 2 to incorporate the selected contextually-relevant information, resulting in a new, marked up document 3. The user computer 20 employs the markup rules 54 to define how the contextually-relevant information will be displayed. The information may be displayed as a modification to the original document 2, such as by visually altering the appearance of the original document with bold, underlined or alternatively colored text, or text in modified font. The information may be displayed as text or other matter added to or overlaid on the original document 2. The information may be displayed in a popup window. These, as well as all useful and practical modes of displaying the information, are within the contemplation of the present invention. In an alternative implementation, the user computer 20 accesses the markup rules 54 residing in the plug-in host 50 to update the markup rules 54 residing in the document reader plug-in 40 prior to performing the document mark up.

Step 8 is to repeat the analysis and markup operations for each matching element within the original document 2. In Step 9, upon completion of the mark up for each matching element, the marked up document 3 is displayed to the user by means of the display 26.

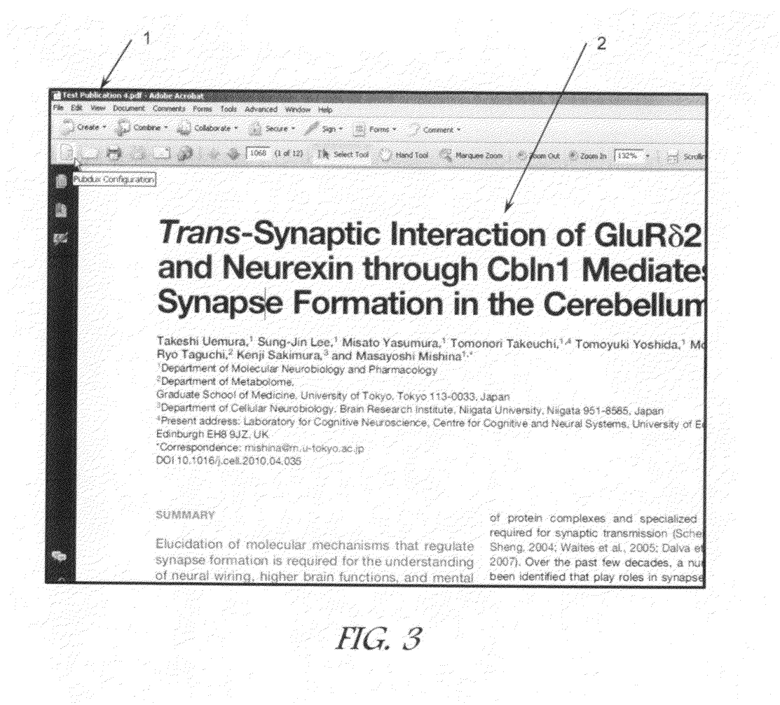

FIG. 3 presents a computer screen shot of an original, pre-markup document 2 opened in the document reader window 1 on the user's display 26. A document reader 32 utilized in a preferred embodiment of the present invention, Adobe Acrobat, is shown in the example of FIG. 3. Alternative embodiments of the present invention may be adapted to usefully employ other document reader applications such as Foxit Reader or Microsoft Word Viewer, among others.

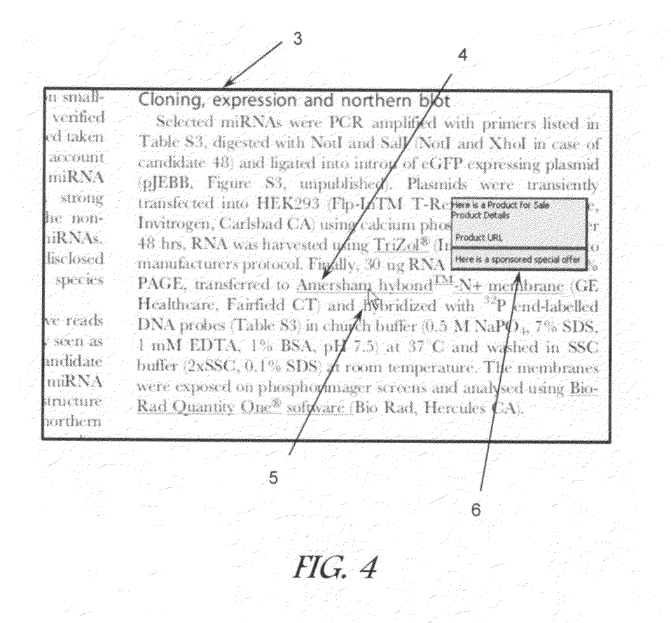

FIG. 4 presents a computer screen shot of the user's computer display 26 showing a portion of the marked up document 3. In this example, a keyword search and contextual analysis using the company name “GE Healthcare” identified that company's product “Amersham hybond-N-+membrane” in document 2. The document markup rules 54 instructed the user computer 20 to transform the product name in the original document 2 into a hyperlink, and to indicate the presence of the hyperlink to the user by displaying the product name as text underlined in red. When the user hovers his cursor 5 over the marked up text 4, a popup window 6 is displayed. In this example, the popup window 6 would be populated with information pertaining to the product “Amersham hybond-N+membrane,” the company's URL to information pertaining to that product, and special offers related to the product.

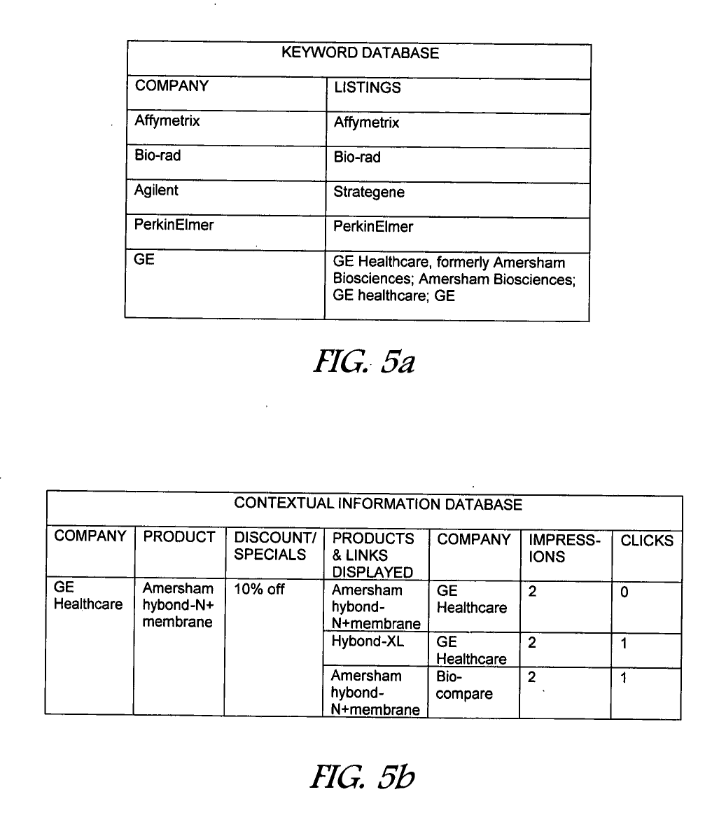

FIG. 5 provides examples of the keyword database 48 and the contextual information database 50 employed to create the marked up document 3 that was presented in FIG. 4. FIG. 5a presents the keyword database 48. In this example, the keyword database contained the names of companies for which markup information was made available. The “Listings” column provides alternative designations of the companies. In this example, “GE Healthcare” was the keyword identified in the original document 2. FIG. 5b presents the contextual information database 50 utilized in the example presented in FIG. 4. Upon recognition of the company “GE Healthcare” and one of that company's products, “Amersham hybond-N+membrane,” the contextual information database 50 identifies the information to be displayed in the markup document 3: discounts/specials associated with that product (column 3 of the table), relevant products and links to information regarding those products (column 4 of the table), and the name of companies associated with those products (column 5). The last two columns of the contextual information database 50 demonstrate the recording of the number of impressions (the number of times the marked up display was made visible to the user) and the number of clicks (the number of times the user selected the displayed link) for each row of information in the table.

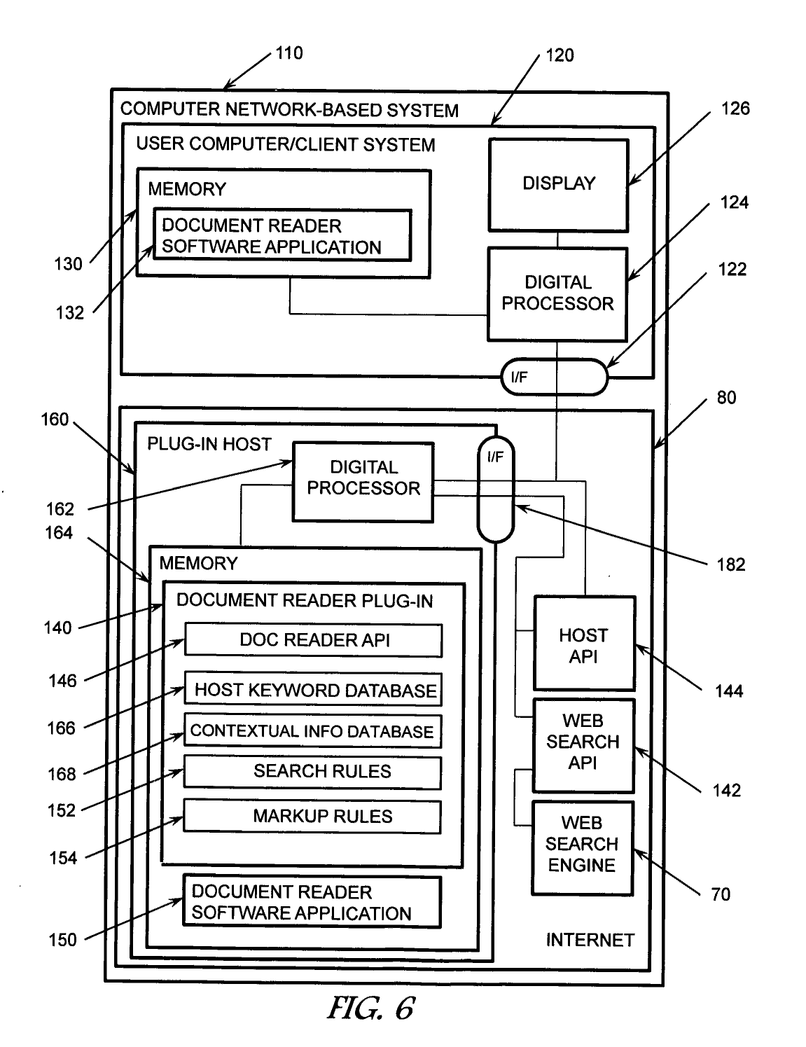

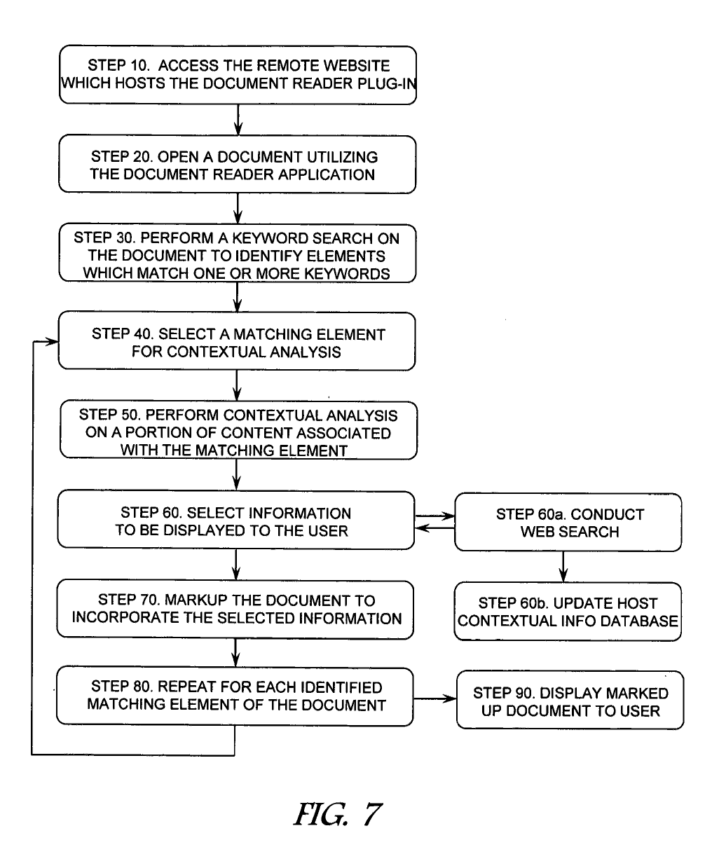

FIG. 6 provides a schematic representation of a second preferred embodiment of the computer network-based system 110 for implementing a second preferred embodiment of the method of the present invention, to be provided in FIG. 7. In this embodiment of the system 110, the document reader plug-in 140 is hosted in the memory 164 of the plug-in host 160. The computer network-based system 110 is comprised of the user computer/client system 120, the Web-based plug-in host 160, and, within the Internet environment 80, the host API 144 for interfacing with the remotely-located plug-in host 160, the Web search API 142 for interfacing with the remotely-located Web search engine 70, and the Web search engine 70.

The user computer/client system 120 is comprised of a digital processor 124, a memory 130, a network interface 122 designed and configured to provide access to the Internet 80, and a display 126. The memory 130 hosts a document reader application 132.

In one preferred embodiment of the present invention, the plug-in host 160 is comprised of a digital processor 162, a memory 164 and a network interface 182 designed and configured to provide access to the Internet 80. The memory 164 hosts the document reader plug-in 140, and a document reader software application 150. The document reader plug-in 140 hosts a document reader document reader API 146 for interfacing with the document reader application 150. The document reader plug-in 140 also hosts search rules 152 and markup rules 154 which contain instructions for the search and markup functions, respectively. Finally, the document reader plug-in 140 hosts the host keyword database 166, which is utilized by the search rules 152, and the contextual information database 168, which is utilized by the markup rules 154. The host keyword database 166 contains the latest updated keyword search data, and the host contextual information database 168 which contains the latest updated contextual information data.

In an alternative embodiment of the computer network-based system, the document reader plug-in may be hosted on a third-party server or website, remote from the user computer/client system or the plug-in host.

FIG. 7 provides a process flow diagram showing the steps in a second preferred embodiment of the method of the present invention. In Step 10, the end user accesses the remote website which hosts the document reader plug-in 140. In the computer network-based system 110 of FIG. 6, the remote website is the plug-in host 160.

In Step 20, the user opens a document 2 in the plug-in host 160 domain utilizing the document reader application 150. Alternatively, the document may be opened within a Web browser.

Step 30 is to perform a keyword search of the content of the document 2 to identify elements in the document 2 which match one or more keywords. The document reader plug-in 140 employs the host keyword database 166 hosted in the plug-in host memory 164 in accordance with the search rules 152, also hosted in the plug-in host memory 164, to identify matching elements within the content of the document 2 on which to perform contextual analysis.

In Step 40, a first matching element is selected for contextual analysis. Step 50 is to perform contextual analysis on a portion of the content of the document 2 associated with the first matching element. The document reader plug-in 140 employs the host contextual information database 168 in accordance with search rules 152 to identify relevant information within the document 2 associated with the first matching element to further tailor the selection of information to be provided to the user.

In Step 60, the document reader plug-in 140 selects the contextually-relevant information contained in the host contextual information database 168 to be incorporated into the document 2. In one preferred embodiment of the present invention, Step 60a is performed in conjunction with Step 60. In Step 60a, the document reader plug-in 140 interfaces with a Web search engine 70 by means of a Web search API 142 and initiates a search of the Internet 80 for contextually-relevant information that is not currently contained in the host contextual information database 168. This additional contextually-relevant information is added to the contextual information database 168 to ensure that the latest available information is made available for the document markup operation. In Step 60b, this additional information is added to the host contextual information database 168 to enhance the fidelity of the host contextual information database 168 on an on-going basis.

Step 70 is to markup the document 2 to incorporate the selected contextually-relevant information, resulting in a new, marked up document 3. The document reader plug-in 140 employs the markup rules 154 to define how the contextually-relevant information will be displayed. The information may be displayed as a modification to the original document 2, such as by visually altering the appearance of the original document with bold, underlined or alternatively colored text, or text in modified font. The information may be displayed as text or other matter added to or overlaid on the original document 2. The information may be displayed in a popup window. These, as well as all useful and practical modes of displaying the information, are within the contemplation of the present invention.

Step 80 is to repeat the analysis and markup operations for each matching element within the original document 2. In Step 90, upon completion of the mark up for each matching element, the marked up document 3 is displayed to the user by means of the display 126.

The individual steps of the disclosed methods may be modified, interchanged or combined, or additional steps added without departing from the spirit of the invention. Further, the present invention may be exercised in alternative embodiments other than those illustrated in the Figures. In addition, the present invention may be adapted to a variety of applications beyond those enumerated in this disclosure. Such modifications, additions, alternatives and adaptations are within the contemplation of the present invention. The exemplary methods and embodiments disclosed are not intended to limit the scope of this invention. Accordingly, the scope of the invention should be determined not by the embodiments illustrated, but by their legal equivalents, and shall be as broad as the claims will allow.

What is claimed is:

1. A method for developing and delivering contextually-relevant information to the end user of a data network, the data network including at least one server system and at least one client system associated with an end user, the method comprising:
(a) installing a document reader plug-in onto a computer network end user's computer, said document reader plug-in being designed and adapted to add keyword search, contextual search, and document markup capabilities to a document reader software program;
(b) opening a document by means of said document reader software program;
(c) performing a keyword search on said document by means of the document reader plug-in, wherein said keyword search is designed to identify elements of the document content which match one or more keywords from a reference keyword database, to identify at least one matching element within the document;
(d) selecting, by means of the document reader plug-in, a first identified matching element of said document for contextual text search analysis;
(e) performing contextual analysis on a portion of content associated with the first identified matching element, by means of the document reader plug-in, wherein said contextual analysis is designed to identify selected keyword information included within said portion of content that matches selected keyword information from a reference keyword information database;
(f) selecting, by means of the document reader plug-in, contextually-relevant information to be displayed to the end user, said contextually-relevant information being selected from a reference contextual information database;
(g) marking up the document, by means of the document reader plug-in, to incorporate the selected contextually-relevant information to be displayed to the computer network end user;
(h) repeating, for each identified matching element of the document, the steps of selecting a matching element, performing contextual analysis on a portion of content associated with the matching element, selecting contextually-relevant information to be displayed to the end user, and marking up the document to incorporate the contextually-relevant information to be displayed to the computer network end user; and
(i) displaying the marked up document to the computer network end user.

2. The method of claim 1, wherein the document reader plug-in resides on a host site that is remote from the computer network end user's computer.

3. The method of claim 1, wherein contextually-relevant information is displayed to the computer network user within the body of the marked up document.

4. The method of claim 1, wherein existing text of the document is transformed into a hyperlink that is configured and designed to cause the contextually-relevant information to be displayed in response to a user interaction with the hyperlink.

5. The method of claim 1, wherein contextually-relevant information is displayed to the computer network end user upon the detection of a first event or condition at the client system, wherein the first event or condition corresponds to the end user clicking on, or hovering a cursor/pointer over a portion of marked up text.

6. The method of claim 1, wherein contextually-relevant information is displayed to the computer network end user as a pop-up layer.

7. The method of claim 1, wherein the document is in an electronic document reader format.

8. The method of claim 1, wherein the document is in pdf format.

9. The method of claim 1, wherein the document is in html format.

10. The method of claim 1, wherein the document is opened within a Web browser.

11. The method of claim 1, wherein the contextually-relevant information contains advertising content.

12. The method of claim 1, wherein the contextually-relevant information contains links to third party Uniform Resource Locators (URLs) which contain relevant content, information, products or services.

13. The method of claim 1, wherein some or all of the contextually-relevant information is gathered through an online Web search.

14. The method of claim 1, wherein some or all of the contextually-relevant information is gathered through an online Web search, and the contextually-relevant information gathered through the online Web search is incorporated into the contextual information database.

15. The method of claim 1, wherein any instance of a user clicking on any of the contextual relevant information, is tracked in a reference database.

16. A computer network-based system for developing and delivering contextually-relevant information to the end user of a data network, the system comprising:
(a) at least one network end user computer/client system, said network end user computer/client system further comprising at least one digital processor, at least one network interface configured or designed to provide a communication link to other network devices in the computer network, memory, and a display; and
(b) at least one server-based plug-in host, said plug-in host further comprising at least one digital processor, at least one network interface configured or designed to provide a communication link to other network devices in the computer network, and memory; and
(c) a computer software program product, said computer software program product including a computer usable medium having computer readable code embodied therein, the computer readable code comprising computer code for implementing the method of claim 1;
the system being configured or designed to:
(i) install a document reader plug-in onto a computer network end user's computer, said document reader plug-in being designed and adapted to add keyword search, contextual search, and document markup capabilities to a document reader software program;
(ii) open a document by means of said document reader software program;
(iii) perform a keyword search on said document by means of the document reader plug-in, wherein said keyword search is designed to identify elements of the document content which match one or more keywords from a reference keyword database, to identify at least one matching element within the document;
(iv) select, by means of the document reader plug-in, a first identified matching element of said document for contextual text search analysis;
(v) perform contextual analysis on a portion of content associated with the first identified matching element, by means of the document reader plug-in, wherein said contextual analysis is designed to identify selected keyword information included within said portion of content that matches selected keyword information from a reference keyword information database;
(vi) select, by means of the document reader plug-in, contextually-relevant information to be displayed to the end user, said contextually-relevant information being selected from a reference contextual information database;
(vii) mark up the document, by means of the document reader plug-in, to incorporate the selected contextually-relevant information to be displayed to the computer network end user;
(viii) repeat, for each identified matching element of the document, the steps of selecting a matching element, performing contextual analysis on a portion of content associated with the matching element, selecting contextually-relevant information to be displayed to the end user, and marking up the document to incorporate the contextually-relevant information to be displayed to the computer network end user; and
(ix) display the marked up document to the computer network end user.

17. A computer network-based system for developing and delivering contextually-relevant information to the end user of a data network, the system comprising:
(a) a means for installing a document reader plug-in onto a computer network end user's computer, said document reader plug-in being designed and adapted to add keyword search, contextual search, and document markup capabilities to a document reader software program;
(b) a means for opening a document by means of said document reader software program;
(c) a means for performing a keyword search on said document by means of the document reader plug-in, wherein said keyword search is designed to identify elements of the document content which match one or more keywords from a reference keyword database, to identify at least one matching element within the document;
(d) a means for selecting, by means of the document reader plug-in, a first identified matching element of said document for contextual text search analysis;
(e) a means for performing contextual analysis on a portion of content associated with the first identified matching element, by means of the document reader plug-in, wherein said contextual analysis is designed to identify selected keyword information included within said portion of content that matches selected keyword information from a reference keyword information database;
(f) a means for selecting, by means of the document reader plug-in, contextually-relevant information to be displayed to the end user, said contextually-relevant information being selected from a reference contextual information database;
(g) a means for marking up the document, by means of the document reader plug-in, to incorporate the selected contextually-relevant information to be displayed to the computer network end user;
(h) a means for repeating, for each identified matching element of the document, the steps of selecting a matching element, performing contextual analysis on a portion of content associated with the matching element, selecting contextually-relevant information to be displayed to the end user, and marking up the document to incorporate the contextually-relevant information to be displayed to the computer network end user; and
(i) a means for displaying the marked up document to the computer network end user.
